(19) United States
(12) Patent Application Publication
(10) Pub. No.: US 2009/0271107 A1
(43) Pub. Date: Oct. 29, 2009

(54) Fuel optimization algorithm for integration with navigation systems or direction generation software and fuel price databases

(76) Inventor: Alfred James Smith, Panama City, FL (US)

Correspondence Address: Alfred J. Smith III, 1161 Adrian Way, Milton, FL, 32583, US

(21) Appl. No.: 12/149,134

(22) Filed: Apr. 25, 2008

(51) Int. Cl. G01C 21/34

(52) U.S. Cl. 701/201

(57) ABSTRACT

With rising fuel prices, and only slight advances being made with respect to automobile fuel efficiency, consumers have shown a demand for a process which will provide them with the most efficient way of purchasing fuel. This utility patent provides this exact process, through the employment of existing technology, including but not limited to vehicle fuel efficiency monitoring software, vehicle navigation systems or web-based navigation software, and existing national gas station price databases or user-input-based databases. This proposed process takes into consideration the changes in fuel prices and vehicle fuel efficiency, by adjusting in real-time, the suggested fuel fill-up locations and quantities for two of the three proposed implementation options. This process will provide a more financially efficient way for users to fill their vehicles with fuel.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention pertains to the realm of automobile transportation, both personal and commercial. The specific problem being addressed is an issue of optimizing fuel efficiency in automobiles, through the employment of navigation systems, known fuel prices, and vehicle technology already in common usage. With rising fuel costs and slight to moderate improvement (at best) in the quality of vehicles being produced, with respect to fuel efficiency, individual consumers and businesses alike have sought ways in which they can optimize their fuel consumption. This invention provides a solution that will ensure maximum financial efficiency with respect to automobile fuel consumption.

### BRIEF SUMMARY OF THE INVENTION

This invention partly focuses on the idea that many drivers use navigation systems or websites that provide similar resources. Additionally, newer vehicles have been created with the capability to monitor their own fuel consumption through, but not limited to the rate of fuel consumption (in miles/gallon) and the estimation for the next required fuel tank fill-up (in miles or kilometers). These vehicles have the ability to present this data in a convenient manner to their occupants. This invention seeks to employ the use of these resources in conjunction with one of the following: a pre-existing fuel price database that has been monitored and updated on its own and provides this data to the public, a network and database involving users manually inputting and updating prices from various gas stations across the country, or a combination of both. The focus of this proposed invention seeks to patent the combination of these resources in an algorithm that would provide a given user specific locations at which he or she should purchase a specific amount of fuel along any given trip, in order to maximize the financial efficiency of that trip, with respect to fuel expenses.

### BRIEF DESCRIPTION OF THE SEVERAL VIEWS OF THE DRAWINGS

Not Applicable.

### DETAILED DESCRIPTION OF THE INVENTION

As advances in automotive technology are made, vehicles have been developed with the capability of monitoring their own fuel consumption in real time. These vehicles are able to produce significant data, such as fuel efficiency (in miles per gallon) and even estimations for the next required fuel tank fill-up (in miles), based on the current calculated efficiency, speed of the vehicle, and remaining fuel volume. With this information, drivers have a better idea of how far they can travel before purchasing more fuel.

Vehicle navigation systems and website-based navigation software have begun to replace the use of conventional highway and detailed road maps. Generally, navigation systems or software require only minimal user inputs, such as a start and end point, and provide users with detailed, step-by-step directions, presented in a variety of useful arrangements. Several examples of these arrangements include, but are not limited to shortest route in either travel time or distance, the capability to minimize the use of toll roads, and the ability to maximize the use of or avoid major highways and roads. These navigation systems are considered to be highly accurate and are heavily relied upon.

As fuel prices continue to rise, more and more interest has been directed towards finding the cheapest fuel prices at the individual consumer level. Many consumers will go out of their way to drive to and fill up at the gas stations selling the lowest costing fuel, indicating that there is strong motivation and a market for this proposed product. This invention seeks to take all of the guesswork out of such a process by providing two methods through which a user can optimize his or her fuel expenditures.

The first process involves either the employment of already existing and known databases that display fuel prices at gas stations across the country. Using the knowledge of both the locations of these gas stations and the price of fuel, this process will plot suggested fuel fill-up locations with suggested fuel quantities along a given projected travel route, as indicated by a navigation system or navigation software.

Once a user selects a starting point and final destination for a trip, this process will provide the user with a suggested travel route, complete with suggested fuel fill-up points and fuel quantities. Just like navigation systems or web-based navigation software present different options to their users, this process will present different travel options, such as, but not limited to the following: shortest travel route, in either travel distance or time, with suggested fuel fill-up locations and fuel quantities; or cheapest travel route, based on both fuel price and additional trip costs (tolls, etc). Users will have the ability to select preferences as to which route they would prefer and will be provided with an estimation of the travel cost.

As the fuel efficiency of a given vehicle changes, based on vehicle speed and other factors, this process will adjust in real time to present its users with the most efficient route along which they should travel. This ability to change will also depend on changing fuel prices at gas stations across the country. As fuel prices change and are set for a specific period of time at a given gas station, that price then becomes listed in the database and will adjust suggested travel routes or fill up locations as necessary

The second process is more specific to an in-vehicle navigation system that will allow a user to find the closest gas stations at any given time and list the gas stations by closest distance or price. Once a user has selected his or her preference, the navigation system will describe; in detail, the directions to the specific gas station. Suggested fuel quantities will accompany the directions, based on a computer generated average fuel consumption (economy) over a recent period of time, which is determined by the user. The suggested fuel quantity will be also based on the user's requested number of days or miles until the next fill-up.

This invention relies upon the integration of three separate products that are already in common usage, but creates a unique process through which users will be able to maximize their fuel efficiency. This invention proposes the following implementation options:

A console can be built into a vehicle and employ the use of existing navigation and fuel efficiency technology in conjunction with a national fuel price database that updates in real-time to provide users with suggested fuel fill up locations and quantities. The adjustments in fuel prices will be transmitted to the vehicle via wireless means from various broadcasting points across the country or via satellite.

The second integration option uses an existing stand-alone navigation system that is commonly found in personal vehicles today. This option would use the process as an add-on to existing navigation systems to enhance the products they offer. Using the existing navigation system, users would be provided with the same data as the first option. Again, price changes would be transmitted to the navigation system via wireless means. The navigation system would account for the vehicles efficiency by either using known fuel efficiencies for vehicle types, tying into an existing vehicle fuel efficiency monitoring system, or by relying on user-inputs of average fuel efficiency.

The third integration option would employ the use of web-based navigation aids for those who do not have access to a stand-alone navigation system. By using published vehicle efficiencies or by using user-inputs for average fuel efficiency, web-based navigation aids that produce suggested trip directions can enhance their product by also providing suggested stop locations and fuel quantities to fill up.

This invention targets the specific process of using existing technology to allow consumers or businesses to maximize their fuel expenditures on a day-to-day or specific trip basis. This specific utility patent seeks to patent the process or algorithm of combining the aforementioned technology in order to maximize the financial efficiency of fuel consumption.

The first and second product integration options offer the ability to update, in real-time, the different fuel fill-up locations and fill up amounts. By constantly re-evaluating the fuel efficiency of the vehicle, the system can continuously project how far it will be able to travel without a fill up. As the vehicle's fuel efficiency drops or rises (ex. traffic jam, cruise control applied, etc) the product will automatically adjust the estimation of remaining fuel efficiency and adjust recommended fuel-fill up locations and quantities. Similarly, as advertised fuel prices adjust, given a set time frame to allow the prices to take effect, the system will adjust it's projected fuel fill-up locations and quantities, as fuel prices will be continuously updated and fed to each individual vehicle via means of wireless data transfer.

1) This utility invention seeks to patent the process of using existing automobile technology to continuously monitor any vehicle's fuel efficiency, and through the use of existing navigation systems/web-based software and existing national gas station price databases, combine the processes in order to provide a user with detailed directions as to where to fill up and a suggested quantity to fill up along a desired route in order to maximize fuel efficiency.

2) This utility patent also lays claim to the application of this process with respect to existing conventional navigation systems, built-in navigation systems for automobiles, and web-based navigation/direction software.

3) This utility patent also claims the application of known fuel price databases with respect to normal vehicle travel, allowing its users to select the most desired method of displaying local gas station prices, their distances, and the related directions, so as to offer a more convenient way of purchasing the most inexpensive fuel.
